(19) United States
(12) Patent Application Publication
(10) Pub. No.: US 2010/0044418 A1
(43) Pub. Date: Feb. 25, 2010

(54) Layered-construction Document Storage System

(75) Inventor: Duane Christensen, Hastings, MN (US)

Correspondence Address: Altera Law Group, LLC, 220 S 6 St Suite 1700, Minneapolis, MN, 55402, US

(73) Assignee: Smead Manufacturing Company

(21) Appl. No.: 12/613,020

(22) Filed: Nov. 5, 2009

Related U.S. Application Data
(63) Continuation of application No. 12/100,531, filed on Apr. 10, 2008.
Application No. 12/100,531 is a continuation of application No. 11/331,246, filed on Jan. 12, 2006, now abandoned.
(60) Provisional application No. 60/643,206, filed on Jan. 12, 2005.

(51) Int. Cl. B65D 27/00; B31B 39/00

(52) U.S. Cl. 229/67.1; 493/210

(57) ABSTRACT

A multi-layer file folder is disclosed, in which a laminate is bonded to the exterior of a thick, supporting manila interior element. By means of lamination, combinations of materials can be used which would otherwise be impossible or impractical. The index tab, as viewed from the front of the folder, is the color of the interior element, typically manila, and provides for a high-contrast writing surface on the index tab.

### CROSS REFERENCE TO RELATED APPLICATION

This application claims the benefit of U.S. Provisional Application No. 60/643206 filed Jan. 12, 2005, which hereby is incorporated herein by reference in its entirety.

### FIELD OF THE INVENTION

The present invention is directed to file folder-like products, and more particularly to colored file folders with light-colored index tabs.

### BACKGROUND

File folders and other paper storage systems are of great utility in an office setting. The most common storage system, the common manila folder, for example are widespread and relatively inexpensive, and have convenient tabs suitable for writing. Because the tabs are light-colored, there is no need for using an additional label on the index tabs; any writing on the tabs has a generally high contrast and is therefore easy to read. In an office setting, it is desirable to have folders of different colors and/or materials, so that each color may correspond to a particular set of instructions, for example. A drawback of common manila folders is that to make them in other colors, often involves significant increases in costs, partly because the heavy stock on which they are made is most inexpensively available in manila and because the costs of small run colors in such heavy stock also adds to cost. In addition, darker colors or surface treatments desirable for the exterior of the folder may inhibit the legibility of the index tab. Thus a solution to both problems is needed. Efficiency of manufacturing a variety of colors and other surface treatments at a low cost and not causing damage to the utility of an indicia receiving area (if any) such as an index tab.

An improvement to common manila folders is colored folders, in which the entire folder is produced from a colored paper stock. These colored folders have two primary drawbacks. First, they are relatively expensive compared to manila folders, chiefly because the runs that the factories use to produce these colored folders are generally much smaller in volume than the manila runs, and are therefore more expensive. Second, the index tabs on colored folders are generally dark in color, or at least darker than on the manila folders, so that any writing on the tabs is reduced in contrast and is therefore harder to read. It is undesirable to have to use an additional label for writing on the index tabs, because they are expensive and inconvenient. Accordingly, there exists a need for a relatively inexpensive colored folder with light-colored index tabs, so that any writing on the tabs is high-contrast and is therefore easy to read. Also problematic is a way to produce heavy weight materials needed for folders with new an interesting materials, such as textured or other “fashion” stock as well as non paper materials such as polypropylene, vinyl or the like, which may contains interesting patterns, colors or indicia, not reproducible in manila stock. There are other types of materials, such as anti-microbial and cut free stock which is generally not available in the weights needed for folders and other heavy weight paper storage systems and products. Finally, where the user prefers a dark exterior color for the folder or other storage product, if the interior is also of dark material, which would be the case if the stock was pigment throughout, it would be impossible to write on the tab or interior, as there would be insufficient contrast between the writing and stock material.

There are other issues relevant to the solution of the present invention and they are detailed below.

### BRIEF SUMMARY

The present invention has many facets and only a few are set forth in this summary. Reference should be had to the detailed description and the claims for a full definition of the invention.

In one embodiment there is disclosed a file folder or other document storage system having a first inner layer of first and second sheets, joined to retain documents, and together defining an outer surface; a second outer layer bonded to the first layer and substantially covering the entire outer surface of the first layer; an outer layer laminated to the inner layer; the second layer being thinner than said first layer and defining the exterior color of the folder.

In another embodiment, there is disclosed a document storage system, having a first inner layer of first and second sheets, configured to retain documents, and together defining an outer surface; a second outer layer bonded to the first layer and substantially covering the entire outer surface of the first layer an outer layer laminated to the inner layer; the second layer being lighter than said first layer and defining the exterior surface attribute of the system.

In another embodiment there is disclosed a method of efficiently manufacturing a plurality of file folders with a plurality of surface treatments having at least folder-weight strength, by selecting an inner folder material of common manila stock; selecting a second material having predetermined surface treatments; applying said second material over the exterior surface of the first material to occlude substantially all of the first material, and bonding said materials to each other.

In another embodiment there is disclosed a method of efficiently manufacturing a file folder having an index tab, the folder having dark shade exterior surface and having at least folder-weight strength, have the steps of selecting an inner folder material of light colored common manila stock; selecting a second material having predetermined darker shade; applying said second material over the exterior surface of the first material to occlude substantially all of the first material, and bonding said materials to each other; so that the interior surface of the index tab remains of a light color.

### BRIEF DESCRIPTION OF THE DRAWING

FIG. 1 illustrates a colored folder with light-colored index tabs.

### DETAILED DESCRIPTION OF THE INVENTION

The present invention a layered-construction paper storage system which is described using the “file folder” but I define this to mean a broad range of products, indicated below. The term is a mere convenience for the sake of brevity of description.

The present invention can be applied to other office requisites, such as binders, folios, clip boards, pockets and similar items. The ability to have a range of colors or textures (or other treatment aspects, or surface attribute) despite material limitations is an issue in many office products and this inventive solution applies.

In addition, the present invention includes the use of cut free materials (materials with dulled edges to prevent paper cuts), anti-microbial materials, waterproof materials and scented (included scratch and sniff) as laminates and as base materials. Some of the above materials, like colors, are only available as thin stock, so that lamination onto heavier stock makes them available in configurations, heretofore, impossible and/or prohibitively expensive.

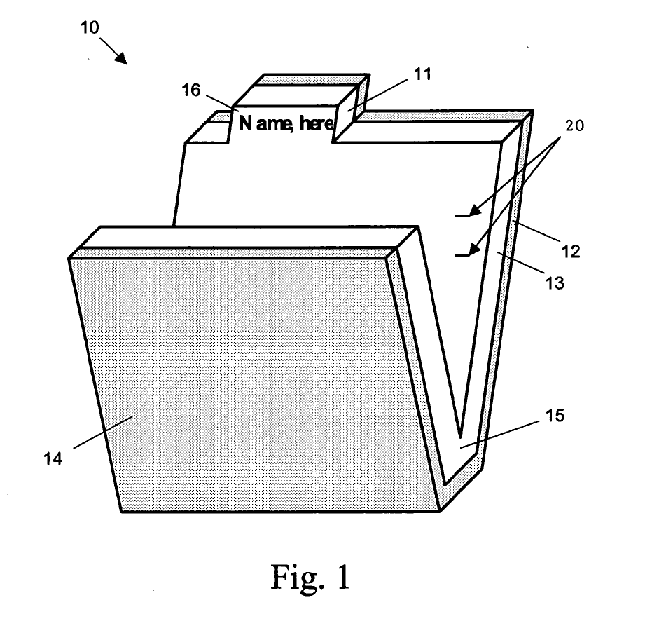

FIG. 1 shows an embodiment of a colored folder 10 with a preferably light-colored index tab 11. The term “light” means light enough to allow written indicia to be visible if written thereon. In the construction of the folder 10, a colored laminate 12 is bonded to a light-colored interior element 13, so that the exterior 14 of the folder 10 appears colored in accordance with the laminate 12, and the index tab 11 appears light-colored in accordance with the interior, element 13. The light colored tab is highly desirable as it allows for writing indicia on the tab whereas dark colors impede this. Dark or darker is defined as a color which would impeded the legibility of written indicia thereon, especially in comparison to a light color. If the folder was made of the same colored material throughout, this would be impossible. Note that if appropriate materials are chosen, then this multi-ply construction may allow for a relatively inexpensive colored folder with light-colored index tabs. Alternatively, the materials chosen may be more expensive than a comparable single-layer folder, such as for a highly textured laminate, a plastic, vinyl, polypropylene, etc. It is also possible that the laminate will have characteristics not possible in the heavy weigh materials, such as patterned materials, as anti-microbial coated materials, “cut-free” edge papers (to prevent papers cuts), laser etchings/holograms, etc. Likewise, the outer laminate may have other characteristics beyond color, such as anti-microbial coating, gripping surfaces, scent impregnated material, or similar non structural characteristics.

Most of the structural support in the folder 10 comes from the interior element 13. The interior element 13 may be made from a manila folder material, which is readily available in a variety of thicknesses and is generally light-colored and inexpensive due to the scale of manufacture. Usually the interior element or layer is heavier (grams/square meter) or thicker or both, such as with a common manila card stock material which I will call “folder weight material” to denote the typical weight/strength of a manila file folder or similar office requisite. Note that for a given thickness, the manila folder material is much less expensive than a comparable colored material, generally because the production runs of the colored or other special materials are much smaller than the manila runs, and are therefore generally more expensive. It is however possible to laminate several layers of materials of varying thickness to achieve the desired thickness and to obtain colored or other layer combinations (per above) in the finished combination. The possibilities of combinations are essentially unlimited, yet cost control is achieved because heavy weight stock having all of these characteristics is not necessary and possibility of maintaining a light colored interior (for tabs and interior notations) is preserved.

The colored laminate 12 is attached to the interior element 13 by bonding. so that the exterior 14 of the folder 10 appears colored in accordance with the laminate 12. The bonding can by glue, adhesive, pressure or other know means. A relatively thin laminate may be used, which may be much thinner than the interior element 13, and may not provide much structural support for the folder 10 compared to the interior element 13. (Note: it is possible that the laminate could be thicker and the interior thinner if desired. Such could be the case where a texture of other specialty paper is desired for the interior.) The thickness of the laminate 12 may be comparable to that of ordinary paper, which is desirable for a number of reasons. Because the colored laminate is relatively thin, it may be inexpensive, since a generally small amount of colored material is required per folder (compared with the relatively thick interior element 13), though even if it were more expensive, the color /texture/coating combination may not be available in the required card (heavy) stock. Thus the inventive solution makes it possible for many more combinations of materials to be manufactured in at a reasonable price and on a made-to-order basis if required. Preferably, the colored laminate may be a plain, thin, colored paper stock, including manila, which is readily available in a wide variety of colors, and is relatively inexpensive because it is regularly produced in large batches. Alternatively, the laminate may be thicker than the interior element, where desired.

A typical manufacturing technique is as follows. The laminate 12 is preferably bonded to the interior element 13 in large, flat sheets or rolls using an adhesive or other suitable bonding agent, then is cut into individual folders 10, preferably including the built-in index tabs 11, and finally folded.

As drawn in FIG. 1, the fold 15 is drawn as having rectangular comers, but the fold 15 may also have a rounded shape. In general, the folding mechanism in the folder 10 is well-known to one skilled in the art, and may include one or more cold score lines or other indentations or perforations, so that the material folds cleanly along one or more predetermined lines without tearing. The folder 10 generally comes pre-folded along a particular fold line, and may include additional score lines so that the user may easily re-fold the folder if it contains an excessive number of documents. Alternatively, the lamination may be used on any paper storage/management product, such as an accordion-style folder, which may have a gusset at the fold (not shown in FIG. 1) , a pocket folder or any similar product. The index tab 11 is generally light colored when viewed from the front of the folder. As drawn in FIG. 1, the index tab 11 has an inscription 16 that is written by the user. Because the user typically uses dark-colored ink, the inscription 16 on the light-colored index tab 11 is of a high contrast, and is therefore easy to read, regardless of the color of the laminate 12. The index tab 11 is drawn in FIG. 1 as offset from the center, but the index tab may also be centered, or may be offset in the opposite direction from the center. Optionally, the folders 10 may be sold in packages that have a number of tabbed folders with a variety of offsets, so that the index tabs may be more visible in a bundled group of folders. In addition to the index tab 11, the interior of the folder 10 is also preferably light-colored, and is therefore suitable for printing or handwritten indicia, or for such things as alignment markers 20 for placement of a paper fastener. Furthermore, note that the light-colored interior of the folder is suitable for index markers, such as where a clip or fastener may be attached. These index markers may not be possible with a folder that has a dark-colored interior. Note that the use of lamination permits single sided preprinting of the folder where the exterior material can be printed on outside and the interior material can be printed on the inside, but neither need be printed on both sides. Embossment may also be easier because the thinner material is easier to emboss.

Note that the lamination scheme described above need not be limited to file folders, and may be applied equally well to file books, portfolios, binder and the like.

The invention also includes a method of manufacturing office requisites such as folders (as defined broadly above), by applying a first layer of one material to a second material and, if required, folding same into the desire shape, such as a folder, in order to obtain an exterior surface of one attribute, and an interior surface of another. A second method involves the manufacturing of an office requisite such as a file folder (defined broadly above) which has a relatively dark shade on the exterior while having a light shade on the interior including the index tab, by applying a darker shaded exterior material to the a lighter interior stock and bonding the two together.

The description of the invention including its applications and advantages as set forth herein is illustrative and is not intended to limit the scope of the invention, which is set forth in the claims. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A file folder, comprising:
a) a first inner layer of first and second sheets, joined to retain documents, and together defining an outer surface;
b) a second outer layer bonded to the first layer and substantially covering the entire outer surface of the first layer an outer layer laminated to the inner layer;
c) said second layer being thinner than said first layer and defining the exterior color of the folder.

2. The folder of claim 1 wherein said layer is bonded by adhesive.

3. The folder of claim 1 wherein said inner layer is a heavier material than said second layer.

4. The folder of claim 1 wherein said outer layer is decorative.

5. The folder of claim 1 wherein said outer layer is colored.

6. The folder of claim 1 wherein said outer layer is includes a scented coating.

7. The folder of claim 1 wherein said outer layer includes an anti-microbial agent.

8. The folder of claim 1 wherein said outer layer includes frictional feature to improve gripping.

9. A document storage system, comprising:
a) a first inner layer of first and second sheets, configured to retain documents, and together defining an outer surface;
b) a second outer layer bonded to the first layer and substantially covering the entire outer surface of the first layer an outer layer laminated to the inner layer;
c) said second layer being lighter than said first layer and defining the exterior surface attribute of the system.

10. A method of efficiently manufacturing a plurality of file folders with a plurality of surface treatments having at least folder-weight strength, comprising:
a) selecting an inner folder material of common manila stock;
b) selecting a second material having predetermined surface treatments;
c) applying said second material over the exterior surface of the first material to occlude substantially all of the first material, and
d) bonding said materials to each other.

11. (canceled)
